(19) United States
(12) Patent Application Publication
(10) Pub. No.: US 2010/0261564 A1
(43) Pub. Date: Oct. 14, 2010

(54) ROTARY TENSIONER

(76) Inventor: Thomas E. Hughes, Wilmington, NC (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/422,638

(22) Filed: Apr. 13, 2009

(51) Int. Cl. F16H 7/12; F16H 7/08

(52) U.S. Cl. 474/135

(57) ABSTRACT

An assembly for maintaining tension in a drive belt features a housing mounted on a base. The housing contains a biasing element that exerts torque on the housing to bias the housing. An arm is connected to the housing and rotates with the housing in response to the bias of the biasing element. A pulley is connected to the lever arm and engages a drive belt in response to the bias force of the biasing element on the lever arm. The pulley deflects the shape of the belt to provide tension in the belt. A sealing element provides prevents migration of debris into the housing and provides a biasing force to impede translatory movement of a first half of the housing from a second half of the housing, while allowing rotation of the first half relative to the second half.

### FIELD OF THE INVENTION

The present invention relates generally to tensioners, and more specifically to mechanical spring-actuated or biased tensioners for use in continuously maintaining tension in endless drive belts or chains in power transmission drive systems.

### BACKGROUND

A variety of tensioners are known in the art for tensioning power transmission drives, such as belts. One type of tensioner uses compression springs to provide the biasing force. Such tensioners are an inexpensive and efficient way to maintain tension in drive belts or chain. However, the known tensioners may face premature failure when operating in harsh environments.

### SUMMARY OF THE INVENTION

In order to overcome the problems associated with premature failure of tensioner assemblies operating in harsh environments, the present invention provides a tensioner assembly adapted to reduce the effects of the environment. Accordingly, the present invention provides a tensioner for tensioning a belt, comprising a housing, an arm attached to the housing and a biasing element positioned within the housing for providing a tensioning force. A sealing element impedes migration of debris into the device that could impair rotation of the arm.

According to one aspect of the invention, a tensioner is provided which includes a housing having a base and a cap that cooperates with the base to form a chamber. A shaft engages the base in such a manner to impede rotation of the shaft relative to the base. A bearing element may be provided between the shaft and the cap to facilitate rotation of the cap relative to the shaft. A biasing element within the chamber biases the cap relative to the base. An elongated arm connected with the housing has an end adapted to be connected with a pulley. A sealing element is provided to impede migration of debris into the housing. In one instance, the sealing element impedes migration of debris into a space between the shaft and the bushing. The sealing element may be deformable and a head of the shaft may deform the sealing element. Additionally, the sealing element may provide a biasing force impeding translatory displacement of the cap relative to the shaft without significantly impeding rotary displacement of the cap relative to the base.

Additionally, according to one aspect of the invention, the sealing element comprises a rim circumscribing the head of the shaft, and a cover projecting inwardly from the rim to cover the bushing. Accordingly, the sealing element may impede migration of debris into a space between the shaft and the bushing.

### DESCRIPTION OF THE DRAWINGS

The foregoing summary and the following detailed description of the preferred embodiments of the present invention will be best understood when read in conjunction with the appended drawings, in which:

FIG. 1 is a perspective view of a tensioner assembly partially in section in combination with an idler pulley.

FIG. 2 is a perspective view of the tensioner illustrated in FIG. 1 without an idler pulley.

FIG. 3 is an enlarged fragmentary sectional view of the tensioner illustrated in FIGS. 1.

FIG. 4 is a plan view of a sealing element of the tensioner illustrated in FIG. 1.

FIG. 5 is a section view of the sealing element illustrated in FIG. 4.

### DETAILED DESCRIPTION OF THE INVENTION

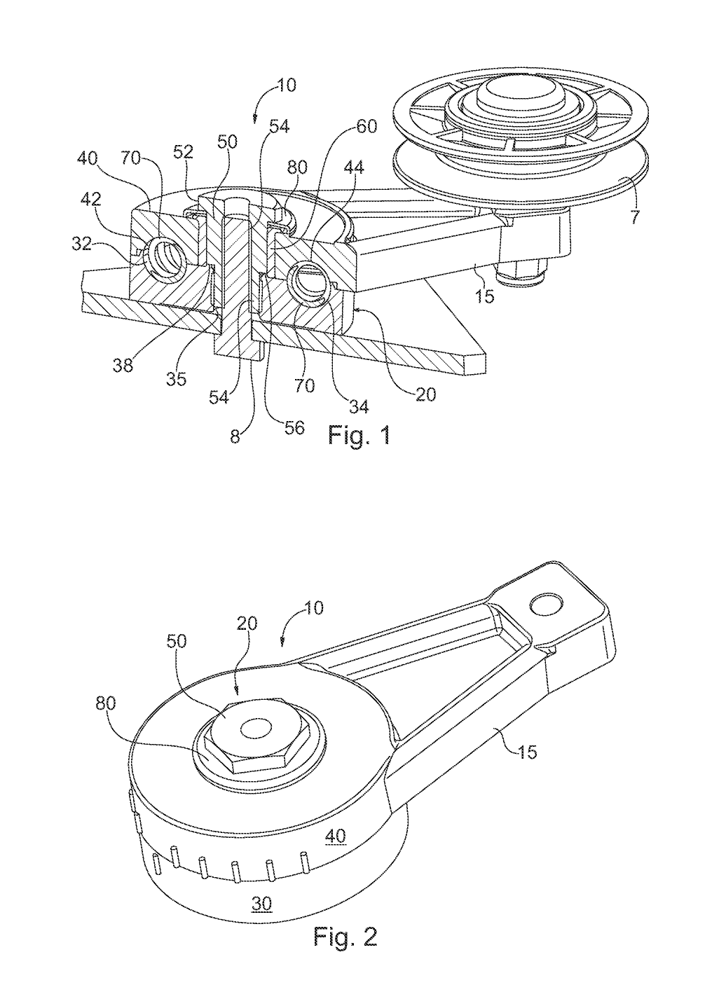

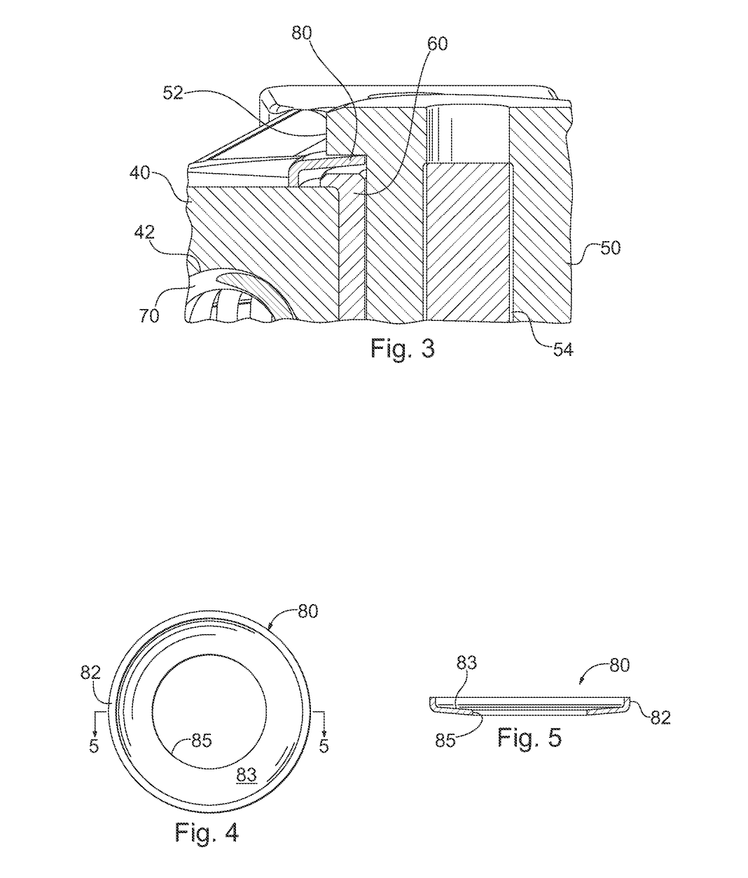

Referring now to the drawings in general, and to FIGS. 1 and 3 specifically, a tensioner apparatus is generally designated 10. The tensioner 10 is operable to bias an idler pulley 7 into engagement with a belt, chain or conveyor. The tensioner 10 includes an arm 15 attached to a housing 20. The arm 15 and a portion of the housing 20 pivot together relative to a base and are under bias from one or more biasing elements 70 in the housing 20. The pulley 7 is connected to the end of the arm 15 and is configured to engage a belt to apply tension to the belt under the bias from the biasing element 70.

Referring now to FIGS. 1-3 the details of the tensioner will be described in greater detail. The tensioner 10 includes a housing 20 that includes two compartments for housing the biasing elements 70. The housing is generally cylindrical, and is formed of a lower portion or base 30, and an upper portion or cap 40. As discussed further below, the compartments housing the biasing elements are formed such that part of each compartment is in the base and part of each compartment is in the cap. In the present embodiment, the biasing elements are springs, so the compartments will be referred to as spring compartments in the following description, however, it should be understood that the biasing element may be in a form other than a spring, such as an elastomeric element.

Referring to FIG. 1, the details of the base 30 will be described in greater detail. The base 30 is generally cylindrical, having a central bore 35. A shaft 50 extends into the bore 35, and a fastener extends through the bore and into the shaft to attach the tensioner to a machine element, as described further below. The base 30 also includes a pair of grooves 32, 34 that form the lower part of spring compartments. Walls between the grooves separate the grooves from one another. The walls operate as end walls that the springs 70 bear against during use of the tensioner.

The grooves 32, 34 are formed in a curved shape. In the present instance, the grooves follow an arc-shaped curve. In the present embodiment, the second groove 34 is substantially a mirror of the first groove 32. Additionally, in the present instance, the bottom surface of grooves 32, 34 are rounded to correspond to the curvature of the convolutions of the springs 70.

The cap 40 overlies the base 30 to enclose the springs 70 within the device. Additionally, an elongated arm 15 is attached to the cap. The arm 15 is configured to be connected with a machine element. For instance, in the present instance, the arm 15 includes a mounting hole positioned remote from the cap 40 that can be used to attach a pulley 7 to the arm so that the tensioner can be used to tension a belt. In the present instance, the arm is integrally formed with the cap so that the arm and cap are a single piece. However, it may be desirable to form the arm and the cap separately so that the arm can be removably attached to the cap if desired.

The cap 40 is in the form of a generally cylindrically-shaped body that is similar to the base 30. The cap also includes a central bore or opening for receiving the shaft 50. The cap 40 comprises two grooves 42, 44 similar to the grooves 32, 34 in the base for housing the springs 70. In this way, when the cap 40 is placed over the base 30, the upper grooves 42, 44 overlie the lower grooves 32, 34 to form compartments for receiving the springs 70.

The tensioner includes at least one biasing element 70. Although the number of biasing elements can vary, in the present instance the tensioner 10 includes two biasing elements 70 that are disposed symmetrically within the housing to balance the biasing forces when the device is rotated. Accordingly, the tensioner includes two similarly configured biasing elements, one in each of the spring compartments.

The cap 40 and the attached arm 15 pivot about a shaft 50, which is connected to the base 30. The shaft is generally cylindrical, having a first end that forms an enlarged diameter head 52 and a second end 54 that forms a smaller diameter, which includes a threaded portion 54. As discussed below, the threaded portion engages the base 30 to connect the shaft to the base in a manner that impedes rotation of the shaft relative to the base.

The shaft 50 is hollow, having a central bore, and the length of the shaft between the head 52 and the threaded portion 54 is generally cylindrical. A shoulder 56 is formed in the shaft adjacent the threaded end 54. The shoulder 56 confronts, but does not necessarily abut the base 20 when the threaded end 54 is threaded into the base 30. The cooperation of the threaded end with the base operates as a stop limiting the distance that the shaft is inserted into the housing. However, as discussed below, in the present instance, the shoulder of the shaft contacts the base, acting as a stop to maintain the proper spacing between the base and the cap.

The bore of the shaft 50 is configured to receive a fastener that is operable to attach the tensioner 10 to a machine element. As illustrated in FIG. 1, the shaft 50 may have an internally threaded bore for attaching the tensioner to a machine. For instance, a fastener, such as a bolt 8, may extend through a plate attached to a machine. The head of the bolt bears against the back of the plate, and the bolt engages the threaded bore of the shaft to attach the tensioner 10 to a machine element. Alternatively, the bore of the shaft may be smooth rather than threaded. The fastener may extend through the bore and be connected via a nut that would bear down against the head of the shaft. Alternatively, the bolt may extend through the shaft so that the head of the bolt bears against the head of the shaft, and the bolt threadedly engages either a tapped hole in a mounting plate or other mounting surface, or the bolt engages a nut on the back side of the mounting surface.

The tensioner 10 operates such that the spring 70 is disposed between the cap 40 and the base 30, and the base is maintained stationary while the cap 40 pivots about the shaft 50 in response to the load on the item being tensioned. To improve the pivoting motion of the tensioner, it may be desirable to include one or more bearing elements between the various elements. For instance, as illustrated in FIG. 1, the present embodiment includes a bushing 60 disposed between the shaft 50 and the cap 40. The bushing 60 is positioned within the cap so that the shaft 50 bears against the interior of the bushing. The bushing 60 is configured to be press fit into the bore though the cap 40 to form a bearing surface between the cap and the shaft. In this way, the bushing provides a smooth wear surface with a relatively low coefficient of friction so that the cap can pivot smoothly relative to the shaft.

The bushing 60 is formed from a material that is softer and/or smoother than the material from which the base, cap and shaft are formed. In this way, the base, shaft and cap can be formed from materials with less regard to wear durability. For instance, the base and cap may be formed of aluminum, the shaft may be formed of steel, and the bushing 60 may be formed of bronze.

The bushing 60 may be a simple cylindrical liner. However, it may be desirable to utilize a bushing having a flared head, as shown in FIG. 1. Specifically, the bushing 60 may include a head that flares outwardly so that the head of the bushing is disposed between the top surface of the housing and the bottom surface of the flared head 52 of the shaft 50. A gap formed between the underside of the flared head 52 of the shaft and the top surface of the bushing 60, ensures that the tensioner is free to rotate without binding.

Referring to FIG. 1, in the present instance, the base 30 includes a boss 38 that forms an annular ridge protruding from the top surface of the base around the central bore 35. The shoulder 56 of the shaft 50 rests on the boss 38 to maintain a gap between the cap and the base 30 to allow the cap to rotate relative to the base. To reduce wear between the base 30, cap 40 and springs 70, preferably the springs are coated with grease in the spring compartments. Additionally, to impede the migration of contaminants between the shaft and the bushing, a sealing element is provided between the head of the bushing 60 and the head of the shaft 50. In the present instance, the sealing element is a resiliently deformable disk, illustrated in FIG. 3-5.

The sealing element 80 comprises a cover that forms a seal between the shaft 50 and the cap 40. The seal 80 comprises a rim 82 that circumscribes the bushing 60 and the bore of the cap 40. In the present instance, the rim 82 is a substantially circular ring having an inner diameter that is greater than the outer diameter of the head of the bushing.

A cover 83 extends inwardly from the rim 82, forming a substantially continuous surface. An aperture 85 in the cover provides an opening to accommodate the body of the shaft 50. The aperture 85 is smaller than the perimeter of the head of the shaft, so that the head overlies the cover 83. In the present instance, the aperture is approximately the same diameter as the body of the shaft 50, or slightly larger. However, if the cover is formed of resiliently deformable material, the aperture may be slightly smaller than the body of the shaft.

Configured as described above, the rim 82 spaces the cover 83 from the surface of the cap 40 to impede interference between the cover 83 and the bushing 60. The outer edge of the cover 83 is supported by the rim, while the interior of the cover, adjacent aperture 85, is unsupported so that the cover is generally free to deform downwardly in response to a force applied downwardly on the cover.

The cover 83 is interposed in the gap between the head of the bushing 60 and the head of the shaft 50. The head of the shaft 50 bears down upon the cover 83 deflecting the cover downwardly. However, a gap remains between the cover 83 ad the head of the bushing to allow free movement between the head of the bushing and the head of the shaft.

The cover may be formed of a variety of materials, such as metal plastic or rubber. In the present instance, the cover 83 is resiliently deformable, and is integrally formed with the rim 82. In the present instance, the rim and cover are integrally formed as a single piece from plastic. Two exemplary plastics include polypropylene and acetal.

Since the cover is formed of a resiliently deformable material, in the present instance, the cover acts as a biasing element to dampen displacement of the cap relative to the base 30. For instance, as discussed above, a gap is formed between the head of the bushing and the head of the shaft. Without the gap, the shaft head would tend to bind against the head of the bushing, thereby preventing the tensioner arm from rotating freely to take up slack in the belt or chain being tensioned. Because of the gap between the head of the bushing and the head of the shaft, the cap may move axially relative to the base. The head of the shaft limits the ability of the cap to move upwardly away from the base. Additionally, as the cap moves upwardly away from the base, the sealing element compresses. As the sealing element 80 deforms, the resilience of the sealing element provides a biasing force biasing the cap 40 downwardly toward the base 30. In this way, the sealing element 80 provides a dampening force impeding displacement of the cap away from the base.

Configured as described above, the tensioner 10 is assembled as follows. The base bushing 60 is press fit into the central hub of the cap 40. The springs 70 are inserted into the spring compartments. Grease is applied to the springs and the cap is placed over the base so that the grooves in the cap 42, 44 overlie the grooves in the base 32, 34. The shaft is then inserted through the aperture 85 in the sealing element 80 and the bore of the cap so that the threaded end 54 threadedly engages the threaded bore 35 in the base. As the shaft is threaded into the base 30, the head of the shaft engages the cover portion 83 of the sealing element 80, deforming the sealing element downwardly toward the cap 40. Since the sealing element is formed of a resiliently deformable material, the resilience in the sealing element biases the inner edge of the cover 83 against the underside of the shaft head 56. At the same time, the compression of the sealing element urges the lower edge of the rim down into a sealing engagement with the cap 40.

In the present instance, a bonding element, such as LOCTITE is applied to the threads to bond the threaded portions together to substantially permanently fix the hub relative to the base. A machine element, such as a pulley is then attached to the end of the arm 15.

A connector, such as a bolt 8, is then used to attach the tensioner to a mounting plate or machine element as described above. The fastener tightens down against the shaft 50 to tighten the base against the machine element. However, the shaft is fixed relative to the base, so that tightening down against the shaft does not significantly tighten the cap against the base. In this way, the cap 40 is free to rotate relative to the base after the device is mounted onto the machine element.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. For instance, in the foregoing description, the tensioner includes a bushing to improve the interface between the shaft, base and housing. In certain applications it may desirable to utilize bearing elements that incorporate ball bearings. Similarly, rather than using a separate bushing, the elements could be plated or coated with a material that provides the desired wear surface. Accordingly, the term bearing element for the shaft, base or housing is meant to include any type of liner, bushing, ball bearing, plating or coating, which provides a property or characteristic separate from the material from which the corresponding element (i.e. the hub, base or housing) is formed. Additionally, in the foregoing description, the biasing element is described as a coil spring in the form of a compression spring in spring chambers formed in the housing. Alternatively, the biasing element may be a spiral torsional spring with one end attached with the base and the other end attached with the housing to provide a biasing force when the cap is rotated relative to the base. In such an embodiment, the spring compartments need not be configured according to the shape of the spring. Instead, the housing may be generally hollow for accommodating the torsional spring. Accordingly, the invention incorporates variations that fall within the scope of the following claims.

1. A tensioner for tensioning a belt, comprising:
a housing, comprising:
a base; and
a cap cooperating with the base to form a chamber;
a shaft engaging the base wherein the shaft has an enlarged head, and the engagement between the shaft and the base impedes rotation of the shaft relative to the base;
a bearing between the shaft and the cap to facilitate rotation of the cap relative to the shaft, wherein a gap is formed between the bushing and the enlarged head of the shaft;
a biasing element within the chamber biasing the cap relative to the base;
an elongated arm having a first end connected with either the base or the cap and a second end remote from the first end, wherein the second end is adapted for being connected with a pulley;
a sealing element disposed in the gap between the bushing and the shaft, wherein the sealing element comprises a rim circumscribing the head of the shaft, and a cover projecting inwardly from the rim, covering the bushing to impede the migration of debris into a space between the shaft and the bushing, wherein the cover is resiliently deformable;
wherein the head of the shaft deforms the sealing elements so that a first portion of the sealing element forms a seal between the sealing element and the shaft, and a second portion of the sealing element forms a seal between the sealing element and the cap, and wherein the sealing element provides a biasing force impeding translatory displacement of the cap relative to the shaft without significantly impeding rotational motion of the cap relative to the shaft.

2. The tensioner of claim 1 wherein the biasing element is a torsion spring.

3. The tensioner of claim 1 wherein the biasing element is a compression spring.

4. The tensioner of claim 1 wherein the sealing element is formed of a resiliently deformable plastic.

5. The tensioner of claim 1 wherein the sealing element comprises an aperture and the shaft passes through the aperture.

6. The tensioner of claim 5 wherein the aperture is smaller than the periphery of the head of the shaft.

7. The tensioner of claim 5 wherein an edge formed by the aperture forms a surface engaging the underside of the head of the shaft.

8. The tensioner of claim 5 wherein the rim of the cover has a height and the width of the cover between the rim and the aperture is at least three times the height of the rim.

9. The tensioner of claim 8 wherein the width of the cover between the rim and the aperture is at least 5 times the height of the rim.

10. The tensioner of claim 1 wherein the rim forms a continuous wall.

11. The tensioner of claim 10 wherein the cover is continuously connected with the rim.

12. The tensioner of claim 1 wherein the bearing element is a bushing.

13. The tensioner of claim 12 wherein the bushing comprises an enlarged head forming a flange, wherein the rim of the sealing element circumscribes the enlarged head.

14. A tensioner for tensioning a belt, comprising:
a housing, comprising:
a base; and
a cap cooperating with the base to form a chamber;
a shaft wherein the shaft has an enlarged head, and the shaft is retained against rotation relative to the base, wherein a gap is formed in an area between the cap and the enlarged head of the shaft;
a biasing element within the chamber biasing the cap relative to the base;
an elongated arm having a first end connected with either the base or the cap and a second end remote from the first end, wherein the second end is adapted for being connected with a pulley;
a sealing element disposed over the gap between the cap and the shaft, wherein the sealing element comprises a peripheral portion circumscribing the head of the shaft, and a cover projecting inwardly from the rim, covering the gap to impede the migration of debris into the gap, wherein the cover is resiliently deformable;
wherein the head of the shaft deforms the sealing elements so that a first portion of the sealing element forms a seal between the sealing element and the shaft, and a second portion of the sealing element forms a seal between the sealing element and the cap.

15. The tensioner of claim 14 wherein the shaft comprises a longitudinal axis and the sealing element provides a biasing force impeding translatory displacement of the cap relative to the axis of the shaft without significantly impeding rotational motion of the cap relative to the shaft.

16. The tensioner of claim 14 wherein the tensioner comprises a bearing between the shaft and the cap to facilitate rotation of the cap relative to the shaft, wherein the gap is formed between the bushing and the enlarged head of the shaft.

17. The tensioner of claim 14 wherein the sealing element comprises an aperture and the shaft passes through the aperture.

18. The tensioner of claim 14 wherein the shaft has a longitudinal axis, and the biasing element biases the cap around the axis of the shaft.

19. A tensioner for tensioning a belt, comprising:
a housing, comprising:
a base; and
a cap cooperating with the base to form a chamber;
a shaft having a head and a longitudinal axis, wherein the shaft is retained against rotation relative to the base, and wherein a gap is formed in an area between the cap and the shaft;
a biasing element within the chamber biasing the cap relative to the base;
an elongated arm having a first end connected with either the base or the cap and a second end remote from the first end, wherein the second end is adapted for being connected with a pulley;
a sealing element covering the gap to impede migration of debris into the gap, wherein the cover is resiliently deformable and the sealing element provides a biasing force impeding translatory displacement of the cap relative to the axis of the shaft without significantly impeding rotational motion of the cap relative to the shaft.

20. The tensioner of claim 19 wherein the head of the shaft deforms the sealing elements so that a first portion of the sealing element forms a seal between the sealing element and the shaft, and a second portion of the sealing element forms a seal between the sealing element and the cap.

21. The tensioner of claim 19 wherein the tensioner comprises a bearing between the shaft and the cap to facilitate rotation of the cap relative to the shaft, wherein the gap is formed between the bushing and the shaft.

22. The tensioner of claim 19 wherein the sealing element comprises an aperture and the shaft passes through the aperture.

23. The tensioner of claim 19 wherein the biasing element biases the cap around the axis of the shaft.
